(19) United States
(12) Patent Application Publication
(10) Pub. No.: US 2016/0226142 A1
(43) Pub. Date: Aug. 4, 2016

(54) PHASE CONTROL FOR ANTENNA ARRAY

(71) Applicant: ROBERT LEROUX, OTTAWA (CA)

(72) Inventor: ROBERT LEROUX, OTTAWA (CA)

(21) Appl. No.: 14/608,865

(22) Filed: Jan. 29, 2015

(51) Int. Cl. H01Q 3/38; H01Q 3/28

(52) U.S. Cl. CPC H01Q 3/38; H01Q 3/28

(57) ABSTRACT

Phase control apparatus and methods for antenna arrays are disclosed. Phase shifting for antenna beam steering or beamforming is broken into a fixed phase shift stage and a variable phase shift stage. The fixed phase shift stage includes one or more fixed phase shift elements with fixed phase shifts. The fixed phase shift stage provides coarse phase control. The variable phase shift stage provides fine phase control with a resolution or granularity that is finer than the fixed phase shifts of the fixed phase shift elements. Amplitude control could also be provided for beam steering, to compensate for amplitude effects of the phase shifting, or both.

### FIELD

The present disclosure relates generally to communications and, in particular, to controlling phase of signals that are received by or are to be transmitted by antenna elements in an antenna array.

### BACKGROUND

Antenna arrays with multiple antenna elements are used in various types of communication equipment. Controlling the phase or both the phase and the amplitude of signals that are fed to and from elements of the antenna array enables steering of antenna beams. This is referred to as beam steering or beamforming. Phase control or phase and amplitude control is applied to signals for transmission from the antenna array and to signals that are received over the air by the antenna array.

### SUMMARY

An embodiment provides an apparatus to control signal phase for an antenna array. The apparatus may include a phase shifter to apply a phase shift to a signal received at an input of the phase shifter. In some embodiments, a gain circuit is coupled to the phase shifter, and is controllable to apply an amplitude gain to a signal received at an input of the gain circuit.

The phase shifter, in one embodiment, includes a fixed phase shift element and a variable phase shift element coupled to the fixed phase shift element. The fixed phase shift element is controllable to apply one of no phase shift and a fixed phase shift. The variable phase shift element is controllable to apply a variable phase shift. A resolution of the variable phase shift of the variable phase shift element is finer than the fixed phase shift.

There could be one or more fixed phase shift elements. For example, a further fixed phase shift element could be coupled to the fixed phase shift element described above. The further phase shift element is controllable to apply one of no phase shift and a fixed phase shift of the further fixed phase shift element, which could the same as or different from the fixed phase shift of the fixed phase shift element.

The fixed phase shift element(s) or the variable phase shift element could be coupled to the input of the phase shifter. Either the fixed phase shift(s) or the variable phase shift could be applied first. Thus, in one embodiment, the fixed phase shift element is coupled to receive the signal at the input of the phase shifter, and the variable phase shift element is coupled to receive an output of the fixed phase shift element. In another embodiment, the variable phase shift element is coupled to receive the signal at the input of the phase shifter, and the fixed phase shift element is coupled to receive an output of the variable phase shift element.

An apparatus could also include a gain circuit to apply amplitude shifting. Either phase shifting or amplitude shifting could be applied first, followed by the other. In an embodiment, the gain circuit could be coupled to the phase shifter and controllable to apply an amplitude gain to an output signal from the phase shifter. The gain circuit could instead be coupled to the phase shifter and controllable to apply an amplitude gain and to provide, at the phase shifter input, an output signal from the gain circuit.

A slow wave phase shifter could be used to implement a fixed phase shift element.

A vector modulator could be used to implement the variable phase shift element.

A variable voltage attenuator could be used to implement the gain circuit.

Communication equipment that includes an antenna array could also include phase shifters. Each phase shifter is coupled to respective antenna element subsets of one or more of the antenna elements of the antenna array, to apply a phase shift to signals received at inputs of the phase shifters. Each of the phase shifters includes a fixed phase shift element controllable to apply one of no phase shift and a fixed phase shift, and a variable phase shift element, coupled to the fixed phase shift element, controllable to apply a variable phase shift. A resolution of the variable phase shift is finer than the fixed phase shift.

Such communication equipment could be user equipment or communication network equipment, for example.

Another example of apparatus disclosed herein includes an antenna array with multiple antenna elements, and phase shifters coupled to respective subsets of one or more of the antenna elements in the antenna array to control phase of signals received by the phase shifters. Each phase shifter includes a digitally controlled coarse phase shifter and an analog controlled fine phase shifter coupled to the coarse phase shifter.

The coarse phase shifter includes a fixed phase shift element that is controllable to apply one of no signal phase shift or a fixed signal phase shift. The fine phase shifter is controllable to apply any of multiple incremental signal phase shifts. A step size between adjacent incremental signal phase shifts of the fine phase shifter is smaller than the fixed signal phase shift.

A signal phase control method for an antenna array is also disclosed, and could involve applying no phase shift or a fixed phase shift to a signal in a fixed phase shift element, and applying a variable phase shift to the signal. A resolution of the variable phase shift is finer than the fixed phase shift.

Such a method could involve first applying no phase shift or the fixed phase shift to the signal in the fixed phase shift elements to generate a phase shifted signal and then applying the variable phase shift to the phase shifted signal. In another embodiment, a method involves first applying the variable phase shift to the signal to generate a phase shifted signal, and then applying no phase shift or the fixed phase shift to the phase shifted signal in the fixed phase shift element.

Amplitude gain could be applied before or after the phase shifting. Thus, in one embodiment a method involves applying an amplitude gain to a phase shifted signal generated by applying no phase shift or the fixed phase shift in the fixed phase shift element and applying the variable phase shift to the signal. A method could instead involve applying an amplitude gain to the signal to generate an amplitude scaled signal, in which case applying phase shift involves applying no phase shift or the fixed phase shift in the fixed phase shift element and applying the variable phase shift to the amplitude scaled signal.

A method could involve repeating the operations of applying no phase shift or a respective fixed phase shift in fixed phase shift elements and applying a variable phase shift for multiple signals associated with respective antenna element subsets that include at least one antenna element of the antenna array.

Such methods could be performed or implemented at user equipment, at communication network equipment, or both.

Other aspects and features of embodiments of the present disclosure will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of an example communication system.

FIG. 2 is a block diagram of example communication equipment.

FIG. 3 is a block diagram of example communication equipment showing a more detailed example of a phase and amplitude controller.

FIG. 4A is a schematic diagram of an example slow wave phase shifter unit cell model.

FIG. 4B is a schematic diagram of an equivalent circuit of the example unit cell model in FIG. 4A.

FIG. 5 is a flow diagram of an example method.

### DETAILED DESCRIPTION

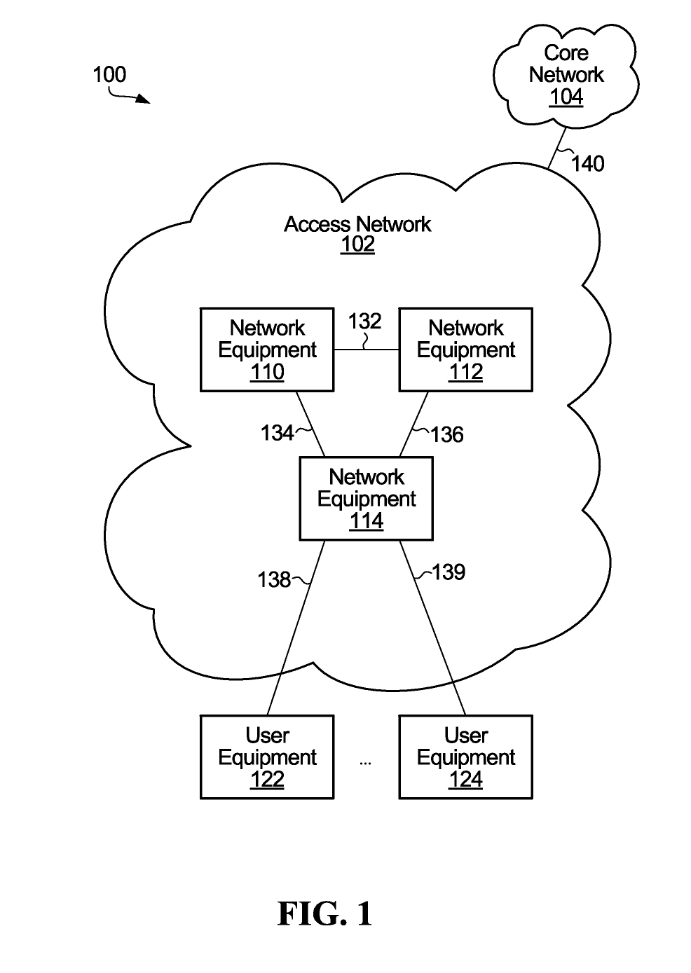

FIG. 1 is a block diagram of an example communication system in which embodiments of the present disclosure could be implemented. The example communication system 100 in FIG. 1 includes an access network 102 and a core network 104. The access network 102 includes network equipment 110, 112, 114 which communicates over network communication links 132, 134, 136. User equipment 122, 124 which communicates with network equipment 114 in the example shown, over access communication links 138, 139. The access network 102 communicates with the core network 104 over another network communication link 140. The core network 104, like the access network 102, may include network equipment that communicates with one or more installations of the network equipment 110, 112 114 in the access network 102. However, in a communication system with an access network 102 and a core network 104, the core network might not itself directly provide communication service to user equipment.

The communication system 100 is intended solely as an illustrative example. An access network 102 could include more or fewer than three installations of network equipment, for example, which might or might not all directly communicate with each other as shown. Also, more than one installation of network equipment in the access network 102 could provide communication service to user equipment. There could be more than one access network 102 coupled to a core network 104. It should also be appreciated that the present disclosure is not in any way limited to communication systems having an access network/core network structure.

More generally, FIG. 1, as well as the other drawings, are intended solely for illustrative purposes. The present disclosure is not limited to the particular example embodiments explicitly shown in the drawings.

Considering first the access network 102, any of various implementations are possible. The exact structure of network equipment 110, 112, 114 is implementation-dependent.

At least the network equipment 114 that provides communication service to the user equipment 122, 124 includes a physical interface and communications circuitry to support access-side communications with the user equipment over the access links 138, 139. The access-side physical interface could be in the form of an antenna or an antenna array, for example, where the access communication links 138, 139 are wireless links. In the case of wired access communication links 138, 139, an access-side physical interface could be a port or a connector to a wired communication medium. Multiple access-side interfaces could be provided at the network equipment 114 to support multiple access communication links 138, 139 of the same type or different types, for instance. The type of communications circuitry coupled to the access-side physical interface(s) at the access network equipment 114 is dependent upon the type(s) of access communication links 138, 139 and the communication protocol(s) used to communicate with the user equipment 122, 124.

The network equipment 110, 112, 114 also includes a network-side physical interface, or possibly multiple network-side physical interfaces, and communications circuitry to enable communications with other network equipment in the access network 102. At least some installations of network equipment 110, 112, 114 also include one or more network-side physical interfaces and communications circuitry to enable communications with core network equipment over the communication link 140. There could be multiple communication links between network equipment 110, 112, 114 and the core network 104. Network-side communication links 132, 134, 136 that are in the access network 102, and the communication link 140 to the core network 104, could be the same type of communication link. In this case the same type of physical interface and the same communications circuitry at the network equipment 110, 112, 114 could support communications between access network equipment within the access network 102 and between the access network 102 and the core network 104. Different physical interfaces and communications circuitry could instead be provided at the network equipment 110, 112, 114 for communications within the access network 102 and between the access network 102 and the core network 104.

Network equipment in the core network 104 could be similar in structure to the network equipment 110, 112, 114. However, as noted above, network equipment in the core network 104 might not directly provide communication service to user equipment and therefore might not include access-side physical interfaces for access communication links or associated access-side communications circuitry. Physical interfaces and communications circuitry at network equipment in the core network 104 could support the same type(s) of network communication link(s) as in the access network 102, different type(s) of network communication link(s), or both.

Just as the exact structure of physical interfaces at network equipment 110, 112, 114 and network equipment in the core network 104 is implementation-dependent, the associated communications circuitry is implementation-dependent as well. In general, hardware, firmware, components which execute software, or some combination thereof, might be used in implementing such communications circuitry. Electronic devices that might be suitable for implementing communications circuitry include, among others, microprocessors, microcontrollers, Programmable Logic Devices (PLDs), Field Programmable Gate Arrays (FPGAs), Application Specific Integrated Circuits (ASICs), and other types of “intelligent” integrated circuits. Software could be stored in memory for execution. The memory could include one or more physical memory devices, including any of various types of solid-state memory devices and/or memory devices with movable or even removable storage media.

The physical structure of user equipment 122, 124 is also implementation-dependent. Each installation of user equipment 122, 124 includes a physical interface and communications circuitry compatible with an access-side physical interface and communications circuitry at the network equipment 114, to enable the user equipment to communicate with the network equipment. Multiple physical interfaces of the same or different types could be provided at the user equipment 122, 124. The user equipment 122, 124 could also include such components as input/output devices through which functions of the user equipment are made available to a user. In the case of a wireless communication device such as a smartphone, for example, these functions could include not only communication functions, but other local functions which need not involve communications. Different types of user equipment 122, 124, such as different smartphones for instance, could be serviced by the same network equipment 114.

Any of the communication links 132, 134, 136, 138, 139, 140, and communication links in the core network 104, could potentially be or include wireless communication links. Such communication links tend to be used more often within an access network 102, or between user equipment 122,124 and an access network, than in a core network 104, although wireless communication links at the core network level are possible. An antenna array including multiple antenna elements could be used at each end of a wireless communication link to enable communications over the air.

Beam steering, also often referred to as beamforming, exploits the effects of signal phase changes or phase and amplitude changes on antenna beam characteristics in a multiple-element antenna array. In a transmit direction, different phase shifts are applied to the same antenna feed signal, which is to be transmitted via the antenna array. The phase shifted versions of the signal, to which the different phase shifts have been applied, are supplied to respective subsets of the antenna elements. Each subset may include a single antenna element or multiple antenna elements. In a receive direction, inverse phase shifts are applied to signals received at corresponding antenna element subsets to generate a received signal for further processing. Amplitude shifts may also be applied.

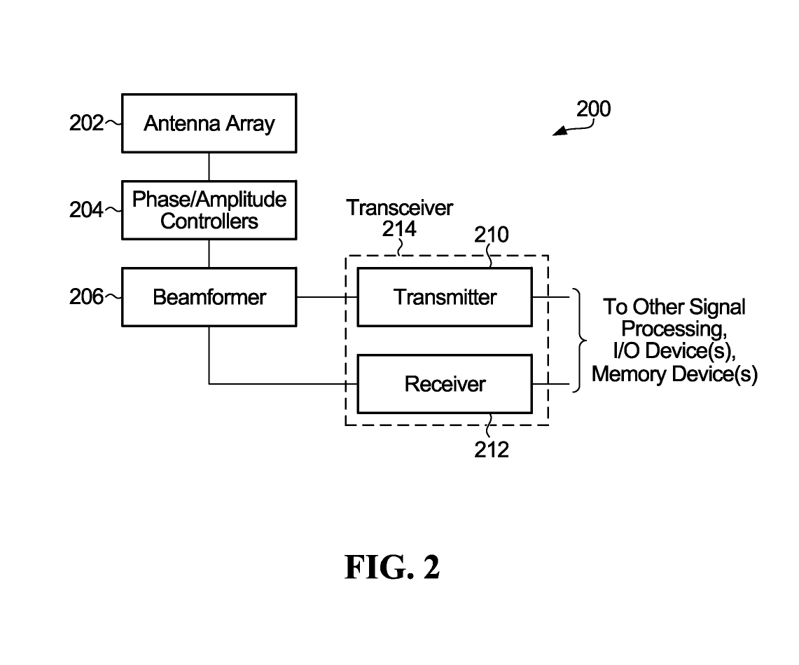

FIG. 2 is a block diagram of example communication equipment 200, which includes an antenna array 202. Phase/amplitude controllers 204 are coupled to the antenna array 202 in the example shown, and a beamformer 206 is coupled to the phase/amplitude controllers. A transmitter 210 and a receiver 212, which could be part of a transceiver 214, are coupled to the beamformer 206. The transmitter 210 and the receiver 212 could also be coupled to other components, such as other signal processing components which further process received signals or perform processing to generate signals for transmission on a wireless communication link through the antenna array 202, one or more input/output devices, and/or one or more memory devices.

The antenna array 202 includes multiple antenna elements, and is an example of a physical interface to a communication medium. The antenna elements could take any of various forms, depending on the type of communication equipment in which the components shown in FIG. 2 are implemented. Patch antenna elements could be implemented in user equipment, for example, where space is limited, whereas larger antenna elements could be implemented in network equipment. Thus, the example communication equipment 200 could be communication network equipment or user equipment. In an embodiment, the components shown in FIG. 2 are implemented at both communication network equipment and user equipment, to enable communications between the network equipment 114 and the user equipment 122, 124 in FIG. 1, for example.

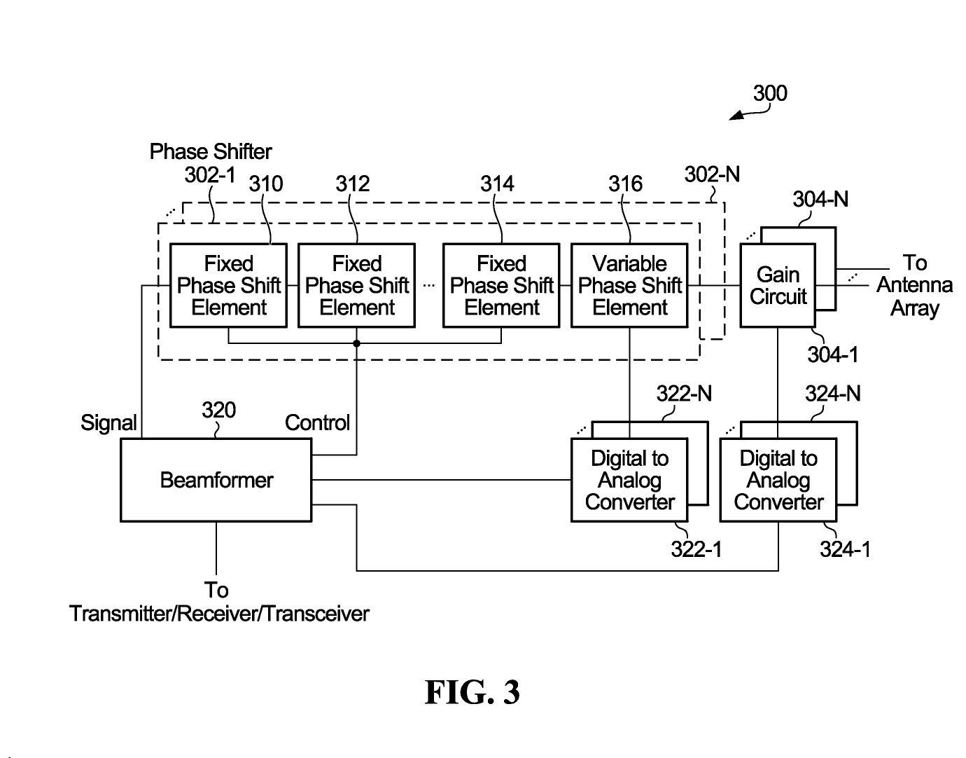

Examples of phase/amplitude controllers 204 are discussed in further detail below with reference to FIG. 3. Each of the phase/amplitude controllers 204 is coupled to a respective subset of one or more antenna elements of the antenna array 202. In one embodiment, each of the phase/amplitude controllers 204 is coupled to a respective single antenna element, although in other embodiments each phase/amplitude controller is coupled to multiple antenna elements.

The beamformer 206 could be implemented in hardware, firmware, or one or more components, such as a processor, that execute software. The transmitter 210 and the receiver 212 could similarly be implemented in hardware, firmware, or one or more components that execute software. Communication equipment need not necessarily support both transmit and receive functions, and therefore in some embodiments only a transmitter 210 or only a receiver 212 might be provided.

Beam steering or beamforming could be implemented in user equipment, communication network equipment, or both. Implementations of the various components of the example communication equipment 200 could be different for different types of communication equipment. As noted above, different types of antenna elements could be implemented in the antenna array 202 depending upon whether the example communication equipment 200 is user equipment or network equipment. Antenna element numbers and designs could depend not only on the physical space available for the antenna array 202, but also or instead on the frequency at which the antenna elements are to be operated and other characteristics of the wireless communication link(s) that are to be provided. It is also possible that communication equipment could include multiple antenna arrays, for different receive and transmit frequencies or different communication links for instance. Network equipment in an access network, for example, could include different antenna arrays for network-side communication links and access-side communication links. Designs of any of the beamformer 206, the transmitter 210, and the receiver 212 could also be different in different types of communication equipment.

In operation, the transmitter 210 could perform such operations as frequency up-conversion, encoding, and modulation, and the receiver 212 could perform inverse operations, including frequency down-conversion, decoding, and demodulation in this example. Transmitters and receivers could perform other operations instead of or in addition to these example operations, depending on the specific implementation and the type(s) of communication functions and protocol(s) to be supported.

Outgoing signals to be transmitted through the antenna array 202 are generated by the transmitter 210 and provided to the beamformer 206, which controls the phase shifts and amplitude shifts that are applied by the phase/amplitude controllers 204. The beamformer 206 could also handle distribution of outgoing signals to the phase/amplitude controllers 204, although this could instead be handled separately in other embodiments. The phase/amplitude controllers 204 feed phase and amplitude shifted transmit signals to the antenna element(s) in the antenna array 202 to which they are coupled.

In the receive direction, signals received at antenna elements of the antenna array 202 are provided to the phase/amplitude controllers 204, which apply phase shifting and amplitude shifting that are complementary to the shifting applied at a transmit end of a wireless communication link. The resultant shifted received signals are combined by the beamformer 206 to generate an incoming signal for processing by the receiver 212.

Regarding amplitude shifting, complementary amplitude shifting of received signals refers to amplitude shifting that is applied for the purpose of beam steering or beamforming. As disclosed herein, amplitude shifts could also or instead compensate for amplitude effects of phase shift elements. For example, a phase shift element might also affect signal amplitude when a phase shift is applied, and an amplitude shift could be applied to compensate for the amplitude effect of the phase shift. For this type of amplitude shift, a receiving phase/amplitude controller 204 applies an amplitude shift to compensate for the amplitude effect of its own phase shift, which is not necessarily complementary to the amplitude shift applied at a transmit end. Thus, an amplitude shift could still be applied at receiving communication equipment, but the receive amplitude shift might not be complementary to the transmit amplitude shift.

There are many techniques for determining phase shifts and amplitude shifts that are to be applied to antenna feed signals. Antenna feed signals could be signals for transmission by the antenna array 202 or signals received by the antenna array. The present disclosure relates to applying shifts to such signals rather than techniques employed by the beamformer 206 for determining the shifts that are to be applied.

In a phased antenna array system, control of the phase or both phase and amplitude of signals going to and from antenna elements in the antenna array enables antenna beam steering. These adjustments should be both precise and repeatable. In a communication system it could also be important not to interrupt the signal path as the changes in phase or phase and amplitude are made, to avoid such effects as a carrier recovery loop becoming unlocked, for instance. Another potential issue facing communication systems is that as wireless communication links move up in frequency towards 80 GHz Eband, for example, much wider channel bandwidths of 500 MHz up to even 1 GHz and wider are involved. It may be desirable to have flat phase response relative to frequency across the bandwidth of a channel, which could become more of a challenge with such very wide bandwidths.

Regarding the actual adjustment or shift of the phase or the phase and amplitude of a Radio Frequency (RF) signal to enable steering of the beam(s) of an antenna array, implementations include a vector modulator that controls both the phase and amplitude with a complex analog control arrangement, and switched phase shift and amplitude steps.

An analog vector modulator with sufficient range to cover 360 degrees of phase shift typically requires extensive calibration in the factory so that the beam shape and angle are known, as there is usually no closed loop feedback in the operating environment. Although phase and amplitude shifts are continuously variable within the number of bits in a Digital to Analog Converter (DAC) when a vector modulator is ultimately controlled by a digital component, a DAC with a high number of bits and large range is required to cover at least 360 degrees of phase shift with sufficient resolution for precise phase and amplitude control. Also, although the basic design of a vector modulator is broadband, it tends to have limited accuracy at the edges of its range and typically does not have flat phase response with frequency. A high-range vector modulator also requires a very stable current source for optimum operation. Due to the large range for beam steering applications, vector modulators can have large phase errors. Although it might be possible to compensate for such errors with calibration, this adds cost.

A switched step implementation, with a digital phase shifter and amplitude control, is generally easier to control, with only simple control lines and without digital to analog conversion, and requires less calibration than a high-range vector modulator. Although switched steps are repeatable, a switched step implementation typically does not have flat phase response with frequency and tends to be more suitable to narrowband applications. Switched steps also involve “break before make” technology, which interrupts a signal path and can be problematic in communications or other applications in which continuous paths or antenna beams are preferred. Granularity or resolution of shifts in a switched step implementation depends on the sizes of the switched steps. Although smaller step sizes provide more granularity or finer resolution between step sizes for a range of shifts, decreasing the step size increases the number of switched steps required to cover the same range of shifts. Switches that are used to implement the switched steps can also introduce error, which can be relatively large especially in comparison with smaller step sizes.

FIG. 3 is a block diagram of example communication equipment showing a more detailed example of a phase and amplitude controller. The example communication equipment 300 includes multiple phase shifters 302-1 to 302-N, multiple gain circuits 304-1 to 304-N respectively coupled to the phase shifters, a beamformer 320 coupled to the phase shifters and to DACs 322-1 to 322-N, 324-1 to 324-N, which are respectively coupled to a variable phase shift element 316 in each phase shifter and to each gain circuit.

In FIG. 3, phase shifting in the phase shifters 302-1 to 302-N is broken into two parts, including fixed phase shifting in fixed phase shift elements 310, 312, 314 and variable phase shifting in the variable phase shift element 316. Although only one phase shifter 302-1 is shown in detail in FIG. 3, any of the phase shifters 302-1 to 302-N can have the same structure in one embodiment.

Each phase shifter 302-1 to 302-N includes fixed phase shift elements 310, 312, 314, three in the example shown, which are serially coupled together. Other embodiments could include more or fewer than three fixed phase shift elements, or in general terms one or more fixed phase shift elements.

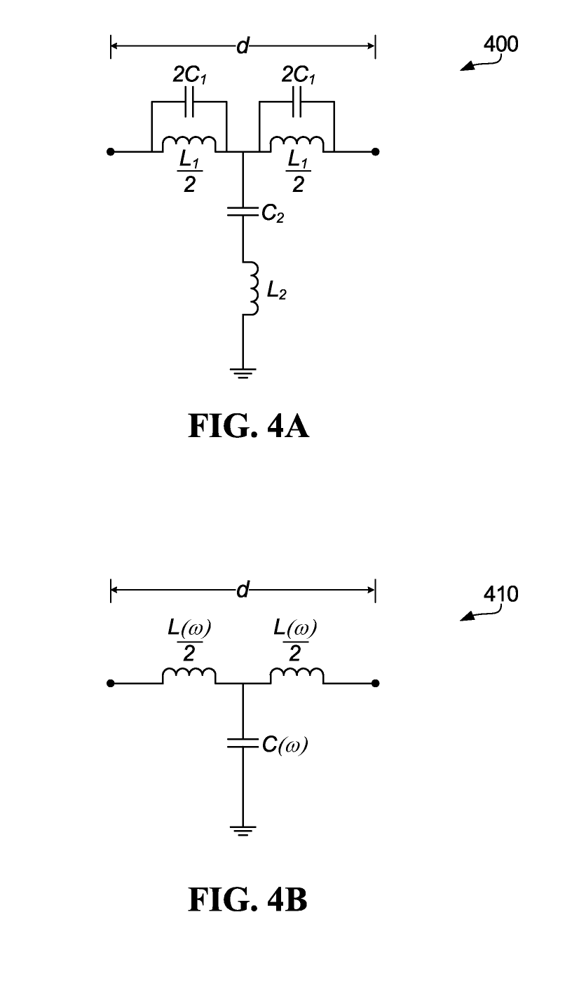

The fixed phase shift elements 310, 312, 314 are digitally controllable by the beamformer 320 in the example shown, for coarse control of the phase of a signal at an input of each of the phase shifters 302-1 to 302-N in the example shown. The fixed phase shift elements 310, 312, 314 have associated respective fixed phase shifts, and could be implemented using lumped elements, transmission lines, or some combination thereof, for example. Slow wave phase shifters are contemplated, and an example of a slow wave phase shifter is discussed below with reference to FIGS. 4A and 4B. The fixed phase shift elements 310, 312, 314 could implement passive coarse steps in passive phase shifters. A passive phase shifter is a structure that causes the phase of an input signal to change without having to apply a stimulus. The above examples of a transmission line, lumped element capacitor/inductor combination and a slow wave phase shifter are types of passive phase shifters.

The respective fixed phase shifts of the fixed phase shift elements 310, 312, 314 could be 45°, 90°, and 180°, for instance, although different fixed phase shifts may be used in other embodiments. Various combinations of these example fixed phase shifts enable phase shifts of up to 315°, with a 45° step size or resolution.

Each fixed phase shift element 310, 312, 314 is controllable to be turned on or off, or to otherwise enable and disable each fixed phase shift element. In one embodiment as shown in FIG. 3, control of the fixed phase shift elements 310, 312, 314 is digitally implemented, but an analog controller could potentially be used in other embodiments.

FIG. 4A is a schematic diagram of an example slow wave phase shifter unit cell model, and FIG. 4B is a schematic diagram of an equivalent circuit of the example unit cell model in FIG. 4A. The example unit cell model 400 in FIG. 4A is a right-handed slow wave phase shifter unit cell model, and includes a transmission line segment of length d, which is modeled by the L₁/2 and 2C₁ combinations, and a load modeled by the C₂ and L₂ combination. The load is controllable to be turned on or off, to load or unload the transmission line. Loading on the transmission line affects the phase shift that is applied to a signal passing through the transmission line. Load control could be provided, for example, by a switch in the circuit path of the load. The equivalent circuit 410 in FIG. 4B includes series inductor, modeled as 2 inductors of inductance L(ω)/2, with a shunt capacitor.

Transmission line dispersion curves in this model could be tailored through periodic, distributed, loading of inductive and capacitive elements. The distributed inductance and capacitance of the L and C components shown in FIG. 4A are frequency dependent. If another transmission line with a different characteristic impedance Z₀ is cascaded to the transmission line in a unit cell modeled by the example model in FIG. 4A, then the second transmission line effectively becomes a series capacitor with a shunt inductor, making the second transmission line look like a left-handed line. It is this change of direction that could provide wider bandwidth with flat dispersion, which could be especially useful for wideband communication systems.

Thus, a slow wave fixed phase shift element could include multiple transmission line segments, which are periodically loaded and unloaded to control whether a fixed phase shift or no phase shift is applied by a particular fixed phase shift element.

Transmission lines in fixed phase shifters could be physically large. In another embodiment, the same electrical effects could be implemented using lumped elements.

The variable phase shift element 316 is coupled to the fixed phase shift elements 310, 312, 314. A vector modulator is an example of a circuit that could be used to implement the variable phase shift element 316. Those skilled in the art will be familiar with various forms of vector modulators that could be implemented as the variable phase shift element 316. A vector modulator is an example of an active phase shifter in which some sort of stimulus is applied to cause the phase of an input signal to change. Another example of an active phase shifter is a varactor diode that is connected to a transmission line. A control voltage is applied to the varactor diode to change the capacitive loading on the transmission line, causing the phase to change. In this case, the control voltage is a stimulus that is applied to cause a change in phase.

The phase shift range of the variable phase shift element 316 that is used in phase control could be selected based on a desired number of control bits of the DACs 322-1 to 322-N and a desired resolution or granularity of the variable phase shift. The range and resolution or granularity of the variable phase shift might also take into account the fixed phase shifts of the fixed phase shift elements 310, 312, 314. For instance, if the smallest fixed phase shift of any of the fixed phase shift elements 310, 312, 314 is 45°, then the variable phase shift element 316 would have finer resolution or higher granularity than 45°, since there is a fixed phase shift element in this example that can provide 45° resolution or granularity. In the above example in which the fixed phase shift elements 310, 312, 314 have respective fixed phase shifts of 45°, 90°, and 180°, the variable phase shift element could have a range of 50°, for example, with much finer resolution or higher granularity than the smallest fixed phase shift of 45°. The resolution or granularity of the variable phase shift element 316 depends on the number of control bits from the beamformer 320 and the size of the DACs 322-1 to 322-N. With 4 control bits and 50° range, for example, the resolution or granularity of the variable phase shift element 316 would be 50°/16. A vector modulator used as the variable phase shift element 316 could have a wider range, but the range used for variable phase shifting in the example communication equipment 300 could be limited to a portion of the full wider range.

In the embodiment shown in FIG. 3, the beamformer 320 provides digital control signals, but control of the variable phase shift element 316 and the gain circuits 304-1 to 304-N is implemented as analog control using the DACs 322-1 to 322-N, 324-1 to 324-N. In other embodiments, analog control signals could be provided and analog control of the variable phase shift element 316 and the gain circuits 304-1 to 304-N could then be implemented without digital to analog conversion.

The gain circuits 304-1 to 304-N could be implemented, for example, using a Variable Voltage Attenuator (WA) having a dual Field Effect Transistor (FET) configuration. A dual FET configuration tends to have low phase change with amplitude, so a low number of bits for the DACs 324-1 to 324-N could be used to achieve a desired amplitude control range. The DACs 322-1 to 322-N may have the same number of input control bits from the beamformer 320 as the DACs 324-1 to 324-N, although this is optional. The number of control bits used for the variable phase shift element 316 in each phase shifter 302-1 to 302-N could be different from the number of control bits used for the gain circuits 304-1 to 304-N.

The beamformer 320, as noted above with reference to the beamformer 206 in FIG. 2, could be implemented in hardware, firmware, or one or more components, such as a processor, that execute software.

Any of various types of DACs could be used to implement the DACs 322-1 to 322-N and 324-1 to 324-N. The size of the DACs 322-1 to 322-N is selected based on desired resolution or granularity of fine phase control by the variable phase shift element 316 in each phase shifter 302-1 to 302-N. Similarly, the size of the DACs 324-1 to 324-N is selected based on desired resolution or granularity of amplitude control by the gain circuits 304-1 to 304-N. In one embodiment, the DACs 322-1 to 322-N and 324-1 to 324-N are 5-bit DACs, including 4 control bits for fine phase control or amplitude control, and one additional bit for calibration. A calibration bit enables compensation for variations between different phase shifters 302-1 to 302-N and between different gain circuits 304-1 to 304-N.

Different numbers of control bits, with different numbers of calibration bits or no calibration bits, could be used in other embodiments. For instance, there could be other ways to deal with variations between different elements, such as fuses that can be blown during factory calibration. In this case, there is factory calibration involving performance measurement in order to determine which fuse(s) to blow, but using fuses to compensate for variations between different elements could reduce the number of calibration bits used in addition to control bits, or eliminate calibration bits entirely.

The phase shifters 302-1 to 302-N break up phase control into passive coarse steps in the fixed phase shift elements 310, 312, 314 and active fine steps in the variable phase shift element 316, in an embodiment. This could help to reduce the phase error over a large adjustment range compared to implementations that use a vector modulator for the full range of phase shifts, since fixed phase shift elements such as 310, 312, 314 tend to have less phase error than a full-range vector modulator, and using a smaller range of variable phase shifting in the variable phase shift element 316 also tends to result in less phase error than a full-range vector modulator.

In one embodiment of the example communication equipment 300, fixed passive phase control by the fixed phase shift elements 310, 312, 314 is followed by variable active phase control, using the variable phase shift element 316 that has a limited range and controls phase for a fine phase shift step. Due to the more limited range of the variable phase shift element 316 when coarse phase control is handled separately in the fixed phase shift elements 310, 312, 314, the accuracy of a limited range vector modulator as the variable phase shift element 316 might be better than that of a full-range vector modulator, and a limited range would use fewer bits from the DACs 322-1 to 322-N than a full-range vector modulator to achieve a step size appropriate for beam steering.

Phase control could thus be broken into a passive block, with passive fixed phase shift elements 310, 312, 314, and an active block, with an active variable phase shift element 316. The passive block in this example has major or coarse phase shift steps, in the fixed phase shift elements 310, 312, 314, that are fixed and might require no calibration. The active block in this example includes the variable phase shifter 316 with a range of variable phase change controlled by an analog control voltage, for fine phase steps. The range of the variable phase shifter 316 that is actually used for fine phase control is relatively small compared to the range of the passive block. In an example above, the fixed phase shift elements 310, 312, 314 provide up to 315° of phase shift with 45° resolution, and a 50° phase shift range of the variable phase shift element 316 is used for fine phase control. This reduces the size of the DACs 322-1 to 322-N compared to a full-range variable phase shift element that is used to provide a full range of phase shifts of at least 360°, and could also make calibration much easier, with a single additional bit for calibration, for example.

Following the phase control or phase adjustment stage in the phase shifters 302-1 to 302-N, the gain circuits 304-1 to 304-N implement an analog amplitude control stage in the example shown. A vector modulator as the variable phase shift element 316 affects signal amplitude in addition to signal phase. The gain circuits 304-1 to 304-N could have a limited range to compensate for amplitude effects of phase control. A dual FET configuration of the gain circuits 304-1 to 304-N, for example, tends to have low phase change with amplitude changes, which might be useful to enable amplitude control without significantly impacting phase. Due to the inherent low amplitude modulation to phase modulation effects in a dual gate device, for example, the phase error associated with using such a device in the gain circuits 304-1 to 304-N could potentially be negligible and simply ignored. Such phase error could instead be compensated during factory setup, which would be a one-time event. Another option would be to provide one or more additional calibration bits at the DACs 324-1 to 324-N as noted above.

Where the gain circuits 304-1 to 304-N are used only to compensate for amplitude effects of the fine phase control by the variable phase control element 316, a limited range and a low number of control bits for the DACs 324-1 to 324-N could be used.

It should be appreciated that the gain circuits 304-1 to 304-N could apply gains that amplify or attenuate input signals. The gains applied by the gain circuits 304-1 to 304-N could be 1, less than 1, or greater than 1.

FIG. 3 is illustrative of a hybrid concept, in which digital control is used for large phase shift steps in the fixed phase shift elements 310, 312, 314, which could be more accurate than using a variable phase shift element such as a vector modulator for a full phase shift range. Since fine phase control is provided separately, in the variable phase shift element 316, larger phase shifts could be provided in the fixed phase shift elements 310, 312, 314. Phase error of switching elements in the fixed phase shift elements 310, 312, 314 could then be so small relative to the fixed phase shifts as to be considered negligible. Similarly, process variation could also be negligible on the scale of the fixed phase shifts.

Switching elements represent one option for controlling which fixed phase shift elements 310, 312, 314 actually apply their fixed phase shift to a signal. In the example shown in FIG. 3, such switching elements are not shown separately. There could be other options for controlling the amount of phase shift that is applied in a fixed phase shift stage by the fixed phase shift elements 310, 312, 314.

In operation, the beamformer 320 determines the phase and amplitude shifts that are to be applied, and controls the phase shifters 302-1 to 302-N and gain circuits 304-1 to 304-N accordingly. Depending on the total phase shift to be applied in each antenna array feed path, the beamformer 320 determines which (if any) of the fixed phase shift element(s) 310, 312, 314 should apply no phase shift, and which (if any) fixed phase shift element(s) should apply their respective fixed phase shift(s).

Embodiments are described in detail above in the context of the illustrative examples in FIGS. 2 to 4. More generally, some embodiments relate to an apparatus to control signal phase, and possibly signal amplitude, for an antenna array. Although an implementation in communication equipment includes multiple phase shifters, a basic building block of a phased antenna array system in such communication equipment could be a single phase shifter.

Phase control for an antenna array could be implemented in an apparatus that includes a phase shifter. The phase shifter is operable to apply a phase shift to a signal received at an input of the phase shifter. FIG. 3 shows an example phase shifter at 302-1.

In accordance with embodiments disclosed herein, the phase shifter includes one or more fixed phase shift elements and a variable phase shift element. Multiple fixed phase shift elements could be serially coupled together. A fixed phase controller is controllable to apply one of no phase shift or a fixed phase shift. FIG. 3 shows such fixed phase shift elements at 310, 312, 314, although in other embodiments there could be one, two, or more than three fixed phase shift elements. A variable phase shift element, such as the variable phase shift element 316 in FIG. 3, is coupled to the fixed phase shift element(s), and is controllable to apply a variable phase shift. A granularity or resolution of the variable phase shift of the variable phase shift element is finer than the fixed phase shift of a fixed phase shift elements. In an embodiment in which there are multiple fixed phase shift elements with respective fixed phase shifts, the granularity or resolution of the variable phase shift of the variable phase shift element could be finer than a smallest of the respective fixed phase shifts of the fixed phase shift elements.

A gain circuit is coupled to the phase shifter in an embodiment as shown in FIG. 3, and is controllable to apply an amplitude gain to a signal received at an input of the gain circuit. The amplitude gain could be a variable amplitude gain in an embodiment. In another embodiment, fixed amplification could be provided using an amplifier, for example, and a variable attenuation could be introduced in another location. Another possible option for amplitude control could involve having a transceiver attenuate a signal by a variable amount and then using a fixed gain circuit.

In the example communication equipment 300 in FIG. 3, a fixed phase shift stage including the fixed phase shift elements 310, 312, 314 is followed by a variable phase shift stage including the variable phase shift element 316. The fixed phase shift element 310, which in this particular example is a first element of multiple serially coupled fixed phase shift elements, is coupled to receive the signal at the input of the phase shifter 302-1. In FIG. 3, this signal at the input of the phase shifter 302-1 is a signal from the beamformer 320. The fixed phase shift element 310 is also coupled to the variable phase shift element 316. In the example embodiment shown in FIG. 3, the fixed phase shift element 310 is indirectly coupled to the variable phase shift element 316. A last element 314 of the serially coupled fixed phase shift elements is coupled to the variable phase shift element 316, in this particular example. The variable phase shift element 316 is coupled to receive an output of the fixed phase shift elements 310, 312, 314, and to provide a phase shifted signal at an output of the phase shifter.

The fixed and variable phase shifts need not be applied in this specific order. For example, the variable phase shift could be applied first, followed by the fixed phase shift(s). In this case, the variable phase shift element is coupled to receive the signal at the input of the phase shifter, a first of the serially coupled fixed phase shift elements is coupled to receive an output of the variable phase shifter, and a last of the serially coupled fixed phase shift elements is coupled to provide a phase shifted signal at an output of the phase shifter. With reference to FIG. 3, the variable phase shift element 316 could receive the signal from the beamformer at the input of the phase shifter 302-1, and the serial chain of fixed phase shift elements 312, 314, 316 could be coupled to an output of the variable phase shift element. More generally, in an embodiment with a single fixed phase shifter such as 310, the variable phase shift element 316 could be coupled to receive the signal at the input of the phase shifter 302-1, and the fixed phase shift element 310 could be coupled to receive an output of the variable phase shift element 316.

The order of phase shifting and amplitude shifting could also or instead be different in different embodiments. For example, as shown in the example communication equipment in FIG. 3, a gain circuit 304-1 could be coupled to a phase shifter 302-1 to receive, at the input of the gain circuit, a phase shifted signal from the phase shifter. In such an embodiment, the gain circuit is controllable to apply an amplitude gain to an output signal from the phase shifter. In another embodiment, the gain circuit is instead coupled to the phase shifter and is controllable to apply an amplitude gain and to provide, at the phase shifter input, an output signal from the gain circuit. The order of the gain circuits and the phase shifters are reversed in this alternate embodiment relative to the order shown in FIG. 3. In this alternate embodiment, the gain circuits are coupled to receive signals from the beamformer and to provide their outputs as inputs to the phase shifters.

As noted above, each of the fixed phase shift elements could include a slow wave phase shifter. A vector modulator is an example of a possible implementation of a variable phase shift element, and a variable voltage attenuator is an example of a possible implementation of a gain circuit.

An apparatus could include an antenna array as well. A component supplier could potentially fabricate or otherwise supply only a phase controller, or multiple phase controllers with an antenna array. Another possible supply chain includes one supplier that supplies phase controllers and another supplier that supplies antenna arrays. In either case, a phased antenna array could be constructed by coupling phase controllers to an antenna array.

Each phase controller includes a respective phase shifter, and forms part of a transmit circuit or a receive circuit for a respective antenna element subset. An antenna element subset includes at least one antenna element of the antenna array. The same phase controller could be used for signal transmission and reception, or different phase controllers could be provided for each antenna element subset. A transmit circuit and a receive circuit could be as simple as a connection to an antenna element subset, although in other embodiments phase controllers are indirectly coupled to their respective antenna element subsets through other components.

The example communication equipment 200 in FIG. 2 includes an antenna array 202 and multiple phase and amplitude controllers 204. Each phase and amplitude controller 204 could include an apparatus with a phase shifter, and possibly a gain circuit, as described herein, and could be coupled to a respective antenna element subset. The communication equipment could be user equipment or communication network equipment, and could include other components such as a beamformer coupled to the phase and amplitude controllers, to determine phase shifts and optionally amplitude shifts to be applied to signals associated with each antenna element subset. These signals could be received signals or signals to be transmitted. Communication equipment could also include a transmitter, a receiver, or both a transmitter and a receiver. A transceiver could include a transmitter and a receiver, as shown in FIG. 2.

Fixed and variable phase shift elements as disclosed herein could be distinguishable from each other not only on the basis of the types of phase shifts that they apply, but also in terms of other characteristics as well. For example, in an apparatus that includes a multiple-element antenna array and phase controllers coupled to respective subsets of one or more of the antenna elements, each phase controller could include one or more fixed phase shift elements in a digitally controlled coarse phase shifter, and an analog controlled fine phase shifter. The coarse phase shifter includes the fixed phase shift element(s) controllable to apply one of no signal phase shift or a fixed signal phase shift, and the analog controlled fine phase shifter is coupled to the coarse phase shifter and controllable to apply any of multiple incremental signal phase shifts. A step size between adjacent incremental signal phase shifts of the fine phase shifter is smaller than the fixed signal phase shift(s) of the fixed phase shift element(s). In an example provided above, the step size between incremental signal phase shifts of a fine phase shifter is 50°/16. The variable phase shift element 316 in FIG. 3 is an example of a fine phase shifter.

Such phase controllers could also include an analog controlled gain circuit, coupled to the coarse phase shifter or to the fine phase shifter, that is controllable to apply a signal amplitude gain. The gain circuits 304-1 to 304-N in FIG. 3 are examples of an analog controlled gain circuit.

FIGS. 2 to 4 present illustrative examples. Other embodiments could include variations from these examples. For instance, phase/amplitude controllers need not necessarily be coupled to an antenna array directly. With reference to FIG. 2, for example, the transmitter 210 could include one or more up-converters to convert signals from baseband to Intermediate Frequency (IF) and from IF to Radio Frequency (RF) for transmission. Phase and amplitude shifts could be applied to IF signals in IF circuitry, further “back” in a transmit path than shown in FIG. 2, within the transmitter 210. Another possible option would be to apply phase and amplitude shifts to signal in a Local Oscillator (LO) path that drives up-converter mixers. Shifting the phase and amplitude of signals that drive such mixers affects the phase and amplitude of the resultant mixed IF or RF signals. In a receive path, phase and amplitude shifting could similarly be applied to IF signals in IF receive circuitry further along in the receive path than shown in FIG. 2 and within the receiver 212, or to signals in an LO path that drives down-converter mixers.

The present disclosure is also not in any way restricted to apparatus or communication equipment. Method embodiments are also contemplated.

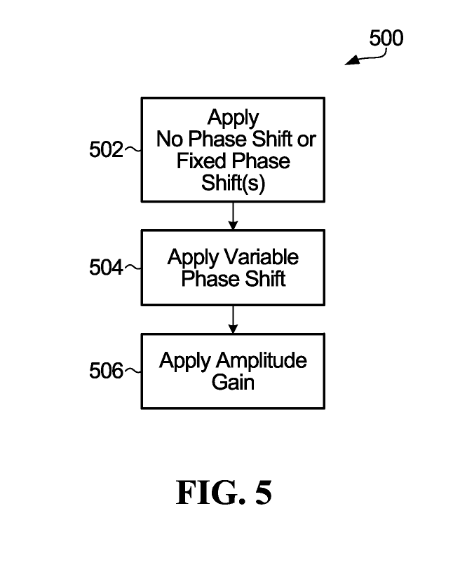

FIG. 5 is a flow diagram of an example method. The example method 500 relates to signal phase and amplitude control for an antenna array, and includes applying no phase shift or a fixed phase shift to a signal in one or more fixed phase shift elements, at 502. A variable phase shift is applied to the signal at 504. A resolution of the variable phase shift is finer than the respective fixed phase shifts of the fixed phase shift elements. At 506, an amplitude gain is applied to the signal.

The example method 500 is illustrative of one embodiment. In other embodiments, similar or different operations could be performed in a similar or different order. Various ways to perform the illustrated operations, as well as examples of other operations that may be performed, are described herein. It should also be noted that not all embodiment involve applying amplitude gain at 506. Further variations may be or become apparent.

For example, in the illustrated embodiment, no phase shift or the fixed phase shift(s) are applied to a signal at 502 in the fixed phase shift element(s) to generate a phase shifted signal, and the variable phase shift is then applied to the phase shifted signal at 504. However, these operations need not be performed in the order shown.

In another embodiment, the variable phase shift is first applied to a signal to generate a phase shifted signal, and no phase shift or the fixed phase shift(s) are then applied to that phase shifted signal in the fixed phase shift element(s). In other words, the operations at 502 and 504 could be reversed.

Similarly, the phase shifts at 502 and 504 could be applied to a signal to generate a phase shifted signal and the amplitude gain could then be applied to the phase shifted signal at 506, as shown in FIG. 5, but in another embodiment the gain is applied first. In this case, a method involves first applying the amplitude gain to a signal to generate an amplitude scaled signal, and then applying no phase shift or the fixed phase shift(s) in the fixed phase shift element(s) and applying the variable phase shift to the amplitude scaled signal. The amplitude scaled signal refers to a signal to which the amplitude gain has been applied. The amplitude gain could scale the signal up in amplitude, scale the signal down in amplitude, or scale the signal to leave its amplitude unchanged in the case of unity gain.

The operations of applying no phase shift or the fixed phase shift(s) in the fixed phase shift element(s) at 502, applying a variable phase shift at 504, and applying an amplitude gain at 506 could be repeated in this order or a different order, for multiple signals associated with respective antenna element subsets that include at least one antenna element of the antenna array.

Methods as disclosed herein could be performed or implemented at user equipment, communication network equipment, or both. In such implementations, there could be additional operations. One example of a possible additional operation is determining the phase shifts to be applied in the fixed phase shift element(s) and the variable phase shift element for signals associated with respective antenna element subsets. Another example is determining gains to be applied to such signals,

A hybrid approach to phase and amplitude control for beam steering or beamforming in accordance with some embodiments disclosed herein could involve much less calibration to achieve a desired accuracy for the beam steering or beamforming. Lower numbers of bits could be used for analog control in some embodiments. Embodiments might also or instead exhibit better repeatability for phase steps.

In one possible embodiment, phase and amplitude control is implemented using a combination of an analog vector modulator and passive phase shifter in a phase control stage with a dual gate VVA in an amplitude control stage. Such an implementation could use a slow wave topology for larger phase shifts, which could increase usable flat phase change bandwidth relative to a phase control implementation that uses a vector modulator for the full range of phase shifts. Other effects of a more limited range for a variable phase shift element could include any one or more of: better phase accuracy which might not need calibration, a lower number of DAC control bits, and lower phase shift with amplitude change due to use of a dual gate FET attenuator which also might not require phase shift compensation. The present disclosure also includes embodiments which do not require “break before make” in phase or amplitude steps, and which are therefore suitable for Frequency Division Duplex (FDD) systems and other systems that involve continuous communication links or channels.

Embodiments could also be useful in Time Division Duplex (TDD) systems, in which phase and amplitude shifts could change on a slot by slot basis, for instance.

Embodiments in which fixed phase shift elements are used in addition to a vector modulator as a variable phase shift element, for example, will occupy more die area than implementations that use an analog vector modulator for the full range of phase shifts. The trade-off in terms of die area might be worthwhile, however, in light of possible advantages that could be attained in embodiments disclosed herein.

What has been described is merely illustrative of the application of principles of embodiments of the present disclosure. Other arrangements and methods could be implemented by those skilled in the art. Although the present disclosure refers to specific features and embodiments, various modifications and combinations could be made. The specification and drawings are, accordingly, to be regarded simply as an illustration of embodiments of the invention as defined by the appended claims, and are contemplated to cover any and all modifications, variations, combinations, or equivalents. Thus, it should be understood that various changes, substitutions and alterations could be made herein without departing from the invention as defined by the appended claims.

Moreover, the scope of the present application is not intended to be limited to particular embodiments of any process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments disclosed herein may be utilized. Accordingly, the appended claims are intended to include within their scope such processes, machines, manufacture, compositions of matter, means, methods, or steps.

For example, any of various applications of phase and amplitude control are possible. One possible market for embodiments disclosed herein is for millimeter wave (mmwave) radios that could be used in a backhaul application where a phased array is used, for instance. Another possible application is for a very high data rate Base Transceiver Station (BTS) to user equipment application, again where a phased array is used. Other applications are also possible. It will be clear to one skilled in the art that the above described methods and apparatuses may be used in future wireless networks including fifth generation (5G) wireless networks.

In addition, although described primarily in the context of methods and systems, other implementations are also contemplated. Through the disclosure provided herein, embodiments may be implemented using hardware only or using a hardware platform to execute software, for example. Embodiments implemented at least in part in the form of a software product are also possible. A software product may be stored in a nonvolatile or non-transitory storage medium, which could be or include a compact disk read-only memory (CD-ROM), Universal Serial Bus (USB) flash disk, or a removable hard disk. More generally, a storage medium could be implemented in the form of one or more memory devices, including solid-state memory devices and/or memory devices with movable and possibly even removable storage media. Such a software product includes a number of instructions, stored on the storage medium, that enable a processor or computer device (personal computer, server, or network device, for example) to execute methods as disclosed herein.

We claim:

1. An apparatus to control signal phase for an antenna array, the apparatus comprising:
a phase shifter to apply a phase shift to a signal received at an input of the phase shifter, the phase shifter comprising:
a fixed phase shift element controllable to apply one of no phase shift and a fixed phase shift;
a variable phase shift element, coupled to the fixed phase shift element, controllable to apply a variable phase shift, a resolution of the variable phase shift being finer than the fixed phase shift.

2. The apparatus of claim 1, wherein the phase shifter further comprises:
a further fixed phase shift element coupled to the fixed phase shift element, the further phase shift element controllable to apply one of no phase shift and a fixed phase shift of the further fixed phase shift element.

3. The apparatus of claim 1, wherein
the fixed phase shift element is coupled to receive the signal at the input of the phase shifter,
the variable phase shift element is coupled to receive an output of the fixed phase shift element.

4. The apparatus of claim 1, wherein
the variable phase shift element is coupled to receive the signal at the input of the phase shifter,
the fixed phase shift element is coupled to receive an output of the variable phase shift element.

5. The apparatus of claim 1, further comprising:
a gain circuit, coupled to the phase shifter, controllable to apply an amplitude gain to an output signal from the phase shifter.

6. The apparatus of claim 1, further comprising:
a gain circuit, coupled to the phase shifter, controllable to apply an amplitude gain and to provide, at the phase shifter input, an output signal from the gain circuit.

7. The apparatus of claim 1, wherein
the fixed phase shift element comprises a slow wave phase shifter.

8. The apparatus of claim 1, wherein
the variable phase shift element comprises a vector modulator.

9. The apparatus of claim 1, further comprising:
a gain circuit, coupled to the phase shifter, controllable to apply an amplitude gain to a signal received at an input of the gain circuit, the gain circuit comprising a variable voltage attenuator.

10. Communication equipment comprising:
an antenna array having a plurality of antenna elements;
a plurality of phase shifters coupled to respective antenna element subsets of one or more of the plurality of antenna elements of the antenna array, to apply a phase shift to signals received at inputs of the phase shifters, each of the phase shifters comprising
a fixed phase shift element controllable to apply one of no phase shift and a fixed phase shift;
a variable phase shift element, coupled to the fixed phase shift element, controllable to apply a variable phase shift, a resolution of the variable phase shift being finer than the fixed phase shift.

11. The communication equipment of claim 10, comprising user equipment.

12. The communication equipment of claim 10, comprising communication network equipment.

13. A signal phase control method for an antenna array, the method comprising:
applying no phase shift or a fixed phase shift to a signal in a fixed phase shift element;
applying a variable phase shift to the signal, a resolution of the variable phase shift being finer than the fixed phase shift.

14. The method of claim 13, comprising:
first applying no phase shift or the fixed phase shift to the signal in the fixed phase shift element to generate a phase shifted signal;
then applying the variable phase shift to the phase shifted signal.

15. The method of claim 13, comprising:
first applying the variable phase shift to the signal to generate a phase shifted signal;
then applying no phase shift or the fixed phase shift to the phase shifted signal in the fixed phase shift element.

16. The method of claim 13, further comprising:
applying an amplitude gain to a phase shifted signal generated by applying no phase shift or the fixed phase shift and applying the variable phase shift to the signal.

17. The method of claim 13, further comprising:
applying an amplitude gain to the signal to generate an amplitude scaled signal,
wherein applying no phase shift or the fixed phase shift in the fixed phase shift element and applying the variable phase shift comprise applying no phase shift or the fixed phase shift in the fixed phase shift element and applying the variable phase shift to the amplitude scaled signal.

18. The method of claim 13, implemented at user equipment.

19. The method of claim 13, implemented at communication network equipment.

20. An apparatus comprising:
an antenna array having a plurality of antenna elements;
a plurality of phase shifters coupled to respective subsets of one or more of the plurality of antenna elements in the antenna array, to control phase of signals received by the phase shifters, each of the phase shifters comprising:
a digitally controlled coarse phase shifter comprising a fixed phase shift element controllable to apply one of no signal phase shift and a fixed signal phase shift;
an analog controlled fine phase shifter, coupled to the coarse phase shifter, controllable to apply any of a plurality of incremental signal phase shifts, wherein a step size between adjacent incremental signal phase shifts of the fine phase shifter are smaller than the fixed signal phase shift.
